(19) United States
(12) Patent Application Publication
(10) Pub. No.: US 2017/0200392 A1
(43) Pub. Date: Jul. 13, 2017

(54) CORE 22 HUMAN TRAINING AND WEIGHT LOSS SYSTEM

(71) Applicants: Sky Leeland Canine, Annapolis, MD (US); Richard Schmitt, Annapolis, MD (US)

(72) Inventors: Sky Leeland Canine, Annapolis, MD (US); Richard Schmitt, Annapolis, MD (US)

(21) Appl. No.: 14/989,868

(22) Filed: Jan. 7, 2016

(51) Int. Cl. G09B 19/00

(52) U.S. Cl. CPC G09B 19/0092; G09B 19/00

(57) ABSTRACT

The system of the preferred embodiments is a method for human training coordinated by a computer interface, where a human user interacts with at least one computing interface; where the at least one computing is provided by a computing device having at least one processor, computer readable storage medium, and a network connection to at least one additional computing device; where the user can enter and read from the computing interface; where the computing device executes computer software code; where the user executes steps displayed by the computing interface related to at least what types of food and how much food the user eats; where the computing interface displays at least once a week at least seven of at least one of questions and instructions to the user related to at least one area including water consumption, types of food eaten, timing of food eaten, type of drink consumed, amount of sleep the user has gotten, dietary supplements taken, amount of food eaten, amount of specific types of foods eaten, whether or not foods eaten fall into certain categories provided to the user in association with the method, characteristics of drink consumed, exercise carried out by the user, amount consumed by the user in certain nutritional categories, food purchased, bowel movements, and resistance of urges; where the user inputs at least one of answers and responses to the at least seven of at least one of questions and instructions; where the computing interface further prompts the user to input at least one of A) the user's weight, B) the user's body fat percentage, C) the user's waist measurements, and D) the user's body mass index; where the computer interface provides the user with a comparison between the user's answers to the at least seven questions to the progress over time of at least one of A) the user's weight, B) the user's body fat percentage, C) the user's waist measurements, and D) the user's body mass index. The method for human training coordinated by a computer interface is preferably designed to help a user lose weight, providing an understanding of the factors that lead to weight loss, providing feedback to the user to give them an understanding of how the factors relate to their weight loss, allowing for social support from others to encourage the user to stay with the program, and manipulating food intake to get the hypothalamus to aide the user in losing weight. The system of the preferred embodiments may, however, be used for any suitable purpose.

### BRIEF DESCRIPTION OF THE FIGURES

FIG. 1 is a schematic representation of a variation of the system of the first preferred embodiments, where an additional user is shown data related to the user's progress in at least one of A) the user's weight, B) the user's body fat percentage, C) the user's waist measurements, and D) the user's body mass index, and information from the additional user's interaction with this data is passed back to the user's computing device.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

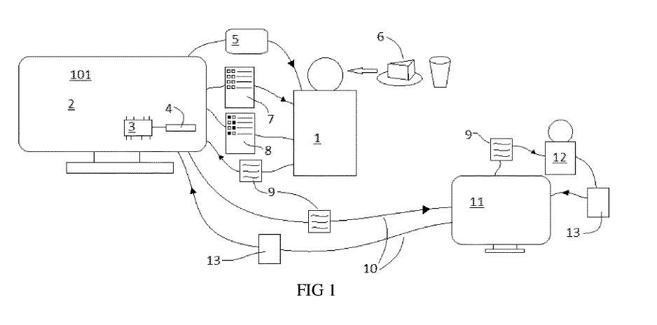

As shown in FIG. 1, the system of the preferred embodiments is a method for human training coordinated by a computer interface, where a human user 1 interacts with at least one computing interface; where the at least one computing is provided by a computing device 101 having at least one processor 3, computer readable storage medium 4, and a network connection 10 to at least one additional computing device 11; where the user 1 can enter and read from the computing interface; where the computing device 101 executes computer software code; where the user 1 executes steps 5 displayed by the computing interface 2 related to at least what types of food 6 and how much food 6 the user 1 eats; where the computing interface 2 displays at least once a week at least seven of at least one of questions 7 and instructions to the user 1 related to at least one area including water consumption, types of food 6 eaten, timing of food 6 eaten, type of drink consumed, amount of sleep the user 1 has gotten, dietary supplements taken, amount of food 6 eaten, amount of specific types of foods 6 eaten, whether or not foods 6 eaten fall into certain categories provided to the user 1 in association with the method, characteristics of drink consumed, exercise carried out by the user, amount consumed by the user 1 in certain nutritional categories, food 6 purchased, bowel movements, and resistance of urges; where the user 1 inputs at least one of answers 8 and responses to the at least seven of at least one of questions 7 and instructions; where the computing interface 2 further prompts the user 1 to input at least one of A) the user's weight 9, B) the user's body fat percentage 9, C) the user's waist measurements 9, and D) the user's body mass index 9; where the computer interface 2 provides the user 1 with a comparison between the user's answers 8 to the at least seven questions 7 to the progress over time of at least one of A) the user's weight 9, B) the user's body fat percentage 9, C) the user's waist measurements 9, and D) the user's body mass index 9. The method for human training coordinated by a computer interface 2 is preferably designed to help a user 1 lose weight, providing an understanding of the factors that lead to weight loss, providing feedback to the user 1 to give them an understanding of how the factors relate to their weight loss, allowing for social support from others to encourage the user 1 to stay with the program, and manipulating food 6 intake to get the hypothalamus to aide the user 1 in losing weight. The system of the preferred embodiments may, however, be used for any suitable purpose.

As shown in FIG. 1, the method for human training coordinated by a computer interface 2 is based around dictating and creating real world actions from a human user 1 which result in physical changes to the user's body. The method at least includes the computing interface 2 providing at least steps 5 that dictate the food 6 and amount of food 6 that the user 1 consumes. In a preferred variation, this may include one or more of: the consumption of dairy, the consumption of wheat, the amount of protein consumed, the amount of fruit consumed, the amount of vegetables consumed, the amount of certain vegetables consumed compared to a list provided to the user 1 with the method, the amount of processed foods 6 consumed, the amount of calories consumed, the amount of food 6 consumed that is not organic, the amount of food 6 consumed that is not farm raised, the amount of plant products consumed that are not grown by organic standards, the amount of farm raised seafood 6 eaten, and the amount of sugar, honey, and artificial sweeteners eaten. In another preferred variation, any suitable standards for the types of food 6 and how the food 6 is grown, raised, and prepared may be used. In a preferred variation, the user 1 may be asked questions 7 related to all of these factors and prompted for a response as to their consumption of these foods 6. In this preferred variation, the user 1 is capable of inputting one or more of data and responses to questions 7 into the at least one computing interface. This may be done with a keyboard, touch screen, computer mouse, voice input, EEG input, eye tracking, measurement sensors, and any other suitable means. In another preferred variation, limits on the amounts of some foods 6 and required amounts of consumption of other foods 6 may be provided to the user. The system may, however, provide any suitable steps 5 related to the amount and types of food 6 consumed by the user.

As shown in FIG. 1, the computing interface 2 preferably prompts the user 1 at least once a week with at least seven questions 7. After years of research and testing in related work on previous systems, it has been shown that there are a minimum of seven critical factors related to weight loss based on the actions taken by the user, and it is key to establish the user's action in these at least seven categories of actions and to determine the link between these factors and weight loss in a particular user. These factors have never been combined in one system in the prior art, and never in one system without the presence of so many other factors that it becomes a burden on the user 1 to actually execute the system. The preferred variation involving prompting the user 1 with at least seven questions 7 a week provides a method not found in prior art for regularly prescribing, monitoring, and educating the behavior of the user. Preferably, the user 1 can input responses to the at least seven questions 7. In a preferred variation, the computer interface 2 then prompts the user 1 to input at least one of A) the user's weight 9, B) the user's body fat percentage 9, C) the user's waist measurements 9, and D) the user's body mass index 9. In a preferred variation, the computing device 101 provides an output that allows the user 1 to compare their answers 8 to the at least seven questions 7 to their progress in at least one of A) the user's weight 9, B) the user's body fat percentage 9, C) the user's waist measurements 9, and D) the user's body mass index 9. This preferably helps teach the user 1 the relationship between the factors covered in the at least seven questions 7 and their ongoing weight loss. In another variation, the questions 7 are instructions given to the user. In a preferred variation, the seven questions 7 include, but are not limited to, at least one area including water consumption, types of food 6 eaten, timing of food 6 eaten, type of drink consumed, amount of sleep the user 1 has gotten, dietary supplements taken, amount of food 6 eaten, amount of specific types of foods 6 eaten, whether or not foods 6 eaten fall into certain categories provided to the user 1 in association with the method, characteristics of drink consumed, exercise carried out by the user, amount consumed by the user 1 in certain nutritional categories, food 6 purchased, bowel movements, and resistance of urges. In another preferred variation, the questions 7 include at least one question related to each of 1) water consumption, 2) timing of food 6 eaten, 3) amount of sleep the user 1 has gotten, 4) amount of food 6 eaten, 5) amount of specific types of foods 6 eaten. In another preferred variation, the at least seven questions 7 include at least one question related to each of: I) if the user 1 slept at least seven hours a night, II) if the user 1 took supplements the method instructed that they take, III) if the user 1 ate only foods 6 approved within the method, IV) amount of vegetables eaten, V) amount of vegetables eaten from a category provided with the method, VI) amount of protein eaten compared to the amount instructed with the method, VII) amount of fruit eaten, VIII) amount of water consumed, IX) if at least one of dairy and wheat was consumed, X) if processed food 6 was eaten, XI) if alcohol was consumed, XII) if at least one of sugar, honey, and artificial sweeteners were consumed, XIII) if animal products were eaten from animals not raised according to standards noted in the materials supplied with the method, XIV) at least one of fruits or vegetables were eaten that were not grown according to standards noted in materials supplied with the method, XV) when the user 1 had bowel movements, XVI) if the user 1 resisted emotional urges to violate the method, and XVII) if the user 1 did not eat within three hours of going to sleep. In another preferred variation, the at least seven questions 7 comprise at least one question related to each of: i) if the user 1 slept at least seven hours a night, ii) if the user 1 took supplements the method instructed that they take, iii) if the user 1 ate only foods 6 approved within the method, iv) amount of vegetables eaten, v) amount of vegetables eaten from a category provided with the method, vi) amount of protein eaten compared to the amount instructed with the method, vii) amount of fruit eaten, viii) amount of water consumed, ix) if at least one of dairy and wheat was consumed, x) if at least one food 6 was consumed that was not at least one of prepared, raised, and grown by standards noted in material included with the method, xi) if alcohol was consumed, xii) if at least one of sugar, honey, and artificial sweeteners were consumed, xiii) if the user 1 did not eat within three hours of going to sleep. In another preferred variation, the at least seven questions 7 comprise at least one question related to each of: aa) if the user 1 slept at least seven hours a night, bb) if the user 1 took supplements the method instructed that they take, cc) amount of vegetables eaten, dd) amount of vegetables eaten, ee) amount of protein eaten compared to the amount instructed with the method, ff) amount of water consumed, gg) if the user 1 did not eat within three hours of going to sleep. In a preferred variation, the at least seven questions 7 are given as a prompt to the user 1 each day. In one preferred variation, the questions 7 include the following: did the user 1 sleep at least 7 hours each night; did the user 1 take the supplements instructed with the materials included with the method; did the user 1 only eat foods 6 approved in the materials included with the method; did the user 1 eat enough of the vegetables listed for high consumption with the materials included with the method; did the user 1 eat no more than a prescribed limit of vegetables not listed for high consumption with the materials included with the method; did the user 1 eat the prescribed amount of protein; did the user 1 eat less than the maximum prescribed amount of fruit; did the user 1 drink at least the prescribed amount of water; was all the water that the user 1 drank at least one of filtered and bottled; did the user 1 avoid consuming alcohol; did the user 1 avoid consuming dairy and wheat; did the user 1 avoid consuming processed food; did the user 1 avoid consuming sugar, honey, and artificial sweeteners; did the user 1 avoid eating beef that was not certified at least one of organic and grass fed; did the user 1 avoid eating fruits and vegetables that were not certified organic; did the user 1 avoid eating within three hours of going to sleep; did the user 1 at least one of purchase and prepare the food 6 they need to continue the proper diet; did the user 1 consume the prescribed amount of salt; did the user 1 have a bowel movement the day before; and did the user 1 have the strength to avoid giving into cravings. There may, however, be any suitable questions 7 or instructions given to the user 1 with any suitable frequency.

As shown in FIG. 1, preferably at least one additional user 12 uses the at least one additional computing device 11 connected by a network connection 10 to the computing device 101. In a preferred variation, the at least one additional user 12 is at least one of a friend, a family member, a coworker, a teammate, and another form of social connection of the user. Preferably the at least one additional user 12 is shown data related to the user's progress in at least one of A) the user's weight 9, B) the user's body fat percentage 9, C) the user's waist measurements 9, and D) the user's body mass index 9. Preferably the software allows the at least one additional user 12 to at least one of 1) display in the software and 2) send the user 1 at least one of a message 13, an e-mail 13, a text message 13, a like 13, and an indicator of social support 13; wherein the at least one of a message 13, an e-mail 13, a text message 13, a like 13, and an indicator of social support 13 provides social support to the user 1 to encourage them to adhere to carrying out the method. In a preferred variation, the at least one additional user 12 may be shown the weight change of the user 1 from the previous day and over the previous week or more, and the at least one additional user 12 may be allowed to send a message to the user. In another preferred variation, the at least one additional user 12 may be shown the weight change of the user 1 from the previous day and over the previous week or more, and the at least one additional user 12 may be allowed to one of ‘like’ and post an indicator of positive feedback in response to the data. Preferably people with at least one of family, professional, and social connections to the user 1 are provided the opportunity to provide social feedback and encouragement to help the user 1 continue to execute the steps 5 of the method. One of the biggest obstacles of any existing human training system is getting the user 1 to follow through with the program and continue the steps 5, unlike prior art systems the system of the preferred embodiments preferably creates an inherent social feedback and support system. In one variation, the user 1 may input their answers 8 to the questions 7, then input their weight, then the computing device 101 may transmit the user's weight 9 and the change of their weight over the past day and a longer time period which may be one week or longer, the at least one additional user 12 then may review the user's weight change and send them a message, which may include something like “Good job!” or “We're all behind you, stay with the program!” In another variation, the at least one additional user 12 may ‘like’ the notification that the user 1 has lost weight, and this may show to at least the user 1 and to any of the additional users supporting the user 1 on a social network application. In another preferred variation, the software may automatically log that the at least one additional user 12 has viewed the data related to the user's progress in at least one of A) the user's weight 9, B) the user's body fat percentage 9, C) the user's waist measurements 9, and D) the user's body mass index 9, and may automatically notify the user 1 that the at least one additional user 12 viewed the data without the at least one additional user 12 taking any action. In this preferred variation, the knowledge that the at least one additional user 12 is watching the progress of the user 1 provides social support and encouragement to the user. In another preferred variation, the at least one additional user 12 may be notified when the user 1 reaches a milestone. In a variation a milestone may include losing ten pounds. In another preferred variation, the at least one additional user 12 may be notified and encouraged to contact the user 1 if the user 1 stops entering data into the at least one computing interface. The at least one additional user 12 may, however, be given any suitable way to interact with the data transmitted to the at least one additional computing device 11. The at least one additional user 12 may, however, not interact at all with the data. There may, however, not be a network connection 10 to an additional computing device 101 and there may not be at least one additional user 12.

In one preferred variation, the user 1 is instructed to consume at least 130% more food 6 than they would normally before carrying out the majority of the steps 5 of the method. This can be at least one of 130% more food 6 by measurement of food 6 quantity, and 130% more calorie content in the consumed foods 6. Preferably this is carried out before any steps 5 involving the user 1 restricting food 6 intake. Preferably this is done for at least one day and no more than a week. In another preferred variation, the user 1 consumes at least 150% more food 6 than they normally would. This increased consumption preferably causes the hypothalamus to trigger a weight loss mode, generally comprising hormonal and appetite changes. This shift with the hypothalamus can preferably be carried through at least a significant portion of the duration of the weight loss portion of the method, in at least one preferred variation.

In a preferred variation, the user 1 is educated on the important factors before beginning the method. This preferably increases their adherence to the method by allowing them to understand why each factor is important. In one preferred variation the user 1 watches videos presented by at least one of DVDs and digital videos that can be used with the at least one computing interface. In a preferred variation, the user 1 is also given at least one of written material and digital documentation on the at least one computing interface 2 that describes information including but not limited to acceptable foods 6, food 6 types, food 6 categories, acceptable drinks for consumption, and any other suitable information. Any suitable data and information may, however, be presented to the user 1 in any suitable form.

In a preferred variation, the at least one computing device 101 calculates the average weekly weight loss of the user 1 and accepts a target weight input from the user. The at least one computing device 101 preferably can project the amount of time it would take the user 1 to reach their target weight at the current average weight loss rate. This preferably serves to encourage the user 1 to maintain the program and understand their progress.

In a preferred variation, the method may begin with questions 7 that help the user 1 identify their current habits and why they have not previously carried out proper weight management habits and observed the important factors identified in the system of the preferred embodiments. It may be important to help the user 1 understand why they carry out their current behaviors in order to allow them to change their behavior. There may, however, be no question prompts related to why the user 1 does what they do.

In a preferred variation of the system of the preferred embodiments, an affiliate organization may present the method and the output on the at least one computing interface 2 may be branded with at least one of logos and the name of the affiliate organization. This affiliate organization may have an interest in being associated with the diet, which may include but is not limited to promotion of their business, sales of products that can be used along with the human training method, attracting members to their organization, and any other suitable incentive. In a preferred variation, the messaging sent to the at least one additional user 12 may also include at least one of a logo and the name of the affiliate organization. In this preferred variation, this may provide at least one of advertising and encouragement for the at least one additional user 12 to also sign up and use the system of the preferred embodiments. In one preferred variation, if the user 1 has fewer than five additional users signed up to act as supporters, the user 1 is encouraged to message more people to get at least five additional users to provide social support for them. In this preferred variation, this also provides a method for the system of the preferred embodiments to gather more users. There may, however, be any suitable organization associated with the system of the preferred embodiments. There may be any suitable logos and names displayed with the messaging involved in the system of the preferred embodiments. There may, however, be no logos and names displayed at all. There may, however, be no encouragement provided to the user 1 to message anyone else. There may, however, be any suitable form of at least one of advertising and encouragement for more people to join any suitable cause. There may, however, by neither of advertising and encouragement for people to join a cause. In a preferred variation, users who at least one of I) have completed the method of the preferred embodiments, and II) are currently working through the method of the preferred embodiments, are encouraged to act as supporters for other users. In this preferred variation these users make particularly effective supporters for users because of their own experiences going through the method. There may, however, be no encouragement provided to current and past users whatsoever. In one variation there may be a progress board where at least two users going through the process of the method of the preferred embodiments can see the progress of the other users. There may, however, be no progress board.

In a preferred variation, at least one additional user 12 acting as a supporter can view a supporter page showing data including one or more of graphs, statistics, physical data, the change of physical data over time for a given user, whether or not a given user 1 has been actively logging into the system, and any other suitable data for at least one user 1 they are supporting, where they are capable of supporting and viewing data for multiple users on their supporter page. In this preferred variation, the supporter can click a given user's name to open a more detailed page with more in depth information about the user. There may, however, be any suitable display for supporters. There may, however, be no supporter page at all.

In a preferred variation, the system shows the user 1 if they have recently made progress towards the goal the user 1 input. If the user 1 has not recently made progress, they are at least one of shown troubleshooting information and invited to click a link to view troubleshooting information. In a preferred variation, this brings them to a page with at least one of video content and troubleshooting information that helps them determine what they are not doing correctly. In a preferred variation of this variation, the at least one of video content and troubleshooting information is selected and delivered to the user 1 based on the responses of the user 1 to the at least seven questions 7. There may, however, be any suitable method of showing the user 1 their progress. There may, however, be any suitable method of helping the user 1 troubleshoot if they are not actively moving towards their goal. There may, however, be no means for troubleshooting whatsoever. There may, however, be no direct display of the user's progress.

In a preferred variation, a graph shows the user 1 their progress. In a preferred variation of this variation, when the user 1 reaches their target, the graph changes to show a flat line very close to the target but in the direction that they have come from and the user 1 is instructed that their goal is to stay on the goal side of the line for thirty days. This trains their body, mind, and habits to stay at their goal. In the variation where the user 1 is losing weight, the flat line may be displayed roughly one pound above the target weight, and maintaining the weight under this level for at least 30 days may help retrain the hypothalamus to maintain that weight level.

As a person skilled in the art will recognize from the previous detailed description and from the figures and claims, modifications and changes can be made to the preferred embodiments of the invention without departing from the scope of this invention defined in the following claims.

We claim:

1) A method for human training coordinated by a computer interface, wherein a human user interacts with at least one computing interface; wherein the at least one computing interface is provided by a device comprising at least one processor and computer readable storage medium; wherein the user can enter and read data from the computing interface; wherein the computing device executes computer software code; wherein the user executes steps displayed by the computing interface related to at least what types of food and how much food the user eats; wherein the computing interface displays at least once a week at least seven questions to the user related to at least one area including water consumption, types of food eaten, timing of food eaten, type of drink consumed, amount of sleep the user has gotten, dietary supplements taken, amount of food eaten, amount of specific types of foods eaten, whether or not foods eaten fall into certain categories provided to the user in association with the method, characteristics of drink consumed, exercise carried out by the user, amount consumed by the user in certain nutritional categories, food purchased, bowel movements, and resistance of urges; wherein the user inputs answers to the at least seven questions; wherein the computing interface further prompts the user to input at least one of A) the user's weight, B) the user's body fat percentage, C) the user's waist measurements, and D) the user's body mass index; wherein the computer interface provides the user with a comparison between the user's answers to the at least seven questions to the progress over time of at least one of A) the user's weight, B) the user's body fat percentage, C) the user's waist measurements, and D) the user's body mass index.

2) The method for human training coordinated by a computer interface of claim 1, wherein the at least seven questions comprise at least one question related to each of 1) water consumption, 2) timing of food eaten, 3) amount of sleep the user has gotten, 4) amount of food eaten, 5) amount of specific types of foods eaten.

3) The method for human training coordinated by a computing interface of claim 2, wherein the at least seven questions comprise at least one question related to each of: I) if the user slept at least seven hours a night, II) if the user took supplements the method instructed that they take, III) if the user ate only foods approved within the method, IV) amount of vegetables eaten, V) amount of vegetables eaten from a category provided with the method, VI) amount of protein eaten compared to the amount instructed with the method, VII) amount of fruit eaten, VIII) amount of water consumed, IX) if at least one of dairy and wheat was consumed, X) if processed food was eaten, XI) if alcohol was consumed, XII) if at least one of sugar, honey, and artificial sweeteners were consumed, XIII) if animal products were eaten from animals not raised according to standards noted in the materials supplied with the method, XIV) at least one of fruits or vegetables were eaten that were not grown according to standards noted in materials supplied with the method, XV) when the user had bowel movements, XVI) if the user resisted emotional urges to violate the method, and XVII) if the user did not eat within three hours of going to sleep.

4) The method for human training coordinated by a computing interface of claim 2, wherein the at least seven questions comprise at least one question related to each of: I) if the user slept at least seven hours a night, II) if the user took supplements the method instructed that they take, III) if the user ate only foods approved within the method, IV) amount of vegetables eaten, V) amount of vegetables eaten from a category provided with the method, VI) amount of protein eaten compared to the amount instructed with the method, VII) amount of fruit eaten, VIII) amount of water consumed, IX) if at least one of dairy and wheat was consumed, X) if at least one food was consumed that was not at least one of prepared, raised, and grown by standards noted in material included with the method, XI) if alcohol was consumed, XII) if at least one of sugar, honey, and artificial sweeteners were consumed, XIII) if the user did not eat within three hours of going to sleep.

5) The method for human training coordinated by a computing interface of claim 2, wherein the computing device further comprises at least one network connection to at least one additional computing device, wherein at least one additional user using the at least one additional computing device connected to the computing device by a network connection is shown data related to the user's progress in at least one of A) the user's weight, B) the user's body fat percentage, C) the user's waist measurements, and D) the user's body mass index; wherein the software allows the at least one additional user to at least one of 1) display in the software and 2) send the user at least one of a message, an e-mail, a text message, a like, and an indicator of social support; wherein the at least one of a message, an e-mail, a text message, a like, and an indicator of social support provides social support to the user to encourage them to adhere to carrying out the method.

6) The method for human training coordinated by a computing interface of claim 4, wherein the computing device further comprises at least one network connection to at least one additional computing device, wherein at least one additional user using the at least one additional computing device connected to the computing device by a network connection is shown data related to the user's progress in at least one of A) the user's weight, B) the user's body fat percentage, C) the user's waist measurements, and D) the user's body mass index; wherein the software allows the at least one additional user to at least one of 1) display in the software and 2) send the user at least one of a message, an e-mail, a text message, a like, and an indicator of social support; wherein the at least one of a message, an e-mail, a text message, a like, and an indicator of social support provides social support to the user to encourage them to adhere to carrying out the method.

7) The method for human training coordinated by a computing interface of claim 2, wherein the computing device further comprises at least one network connection to at least one additional computing device, wherein at least one additional user using the at least one additional computing device connected to the computing device by a network connection is shown data related to the user's progress in at least one of A) the user's weight, B) the user's body fat percentage, C) the user's waist measurements, and D) the user's body mass index; wherein an indicator is automatically provided to the user that the at least one additional user has seen their data when the at least one additional user opens the interface displaying data related to the user's progress in at least one of A) the user's weight, B) the user's body fat percentage, C) the user's waist measurements, and D) the user's body mass index.

8) The method for human training coordinated by a computing interface of claim 4, wherein the computing device further comprises at least one network connection to at least one additional computing device, wherein at least one additional user using at least one additional computing device is shown data related to the user's progress in at least one of A) the user's weight, B) the user's body fat percentage, C) the user's waist measurements, and D) the user's body mass index; wherein an indicator is automatically provided to the user that the at least one additional user has seen their data when the at least one additional user opens the interface displaying data related to the user's progress in at least one of A) the user's weight, B) the user's body fat percentage, C) the user's waist measurements, and D) the user's body mass index.

9) The method for human training coordinated by a computing interface of claim 6, wherein at least one additional user using at least one additional computing device is shown data related to the user's progress in at least one of A) the user's weight, B) the user's body fat percentage, C) the user's waist measurements, and D) the user's body mass index; wherein an indicator is automatically provided to the user that the at least one additional user has seen their data when the at least one additional user opens the interface displaying data related to the user's progress in at least one of A) the user's weight, B) the user's body fat percentage, C) the user's waist measurements, and D) the user's body mass index.

10) The method for human training coordinated by a computing interface of claim 2, wherein the method instructs the user to consume at least 130% more food than they ordinarily would before carrying out steps of the method involving restricting food intake.

11) The method for human training coordinated by a computing interface of claim 4, wherein the method instructs the user to consume at least 130% more food than they ordinarily would before carrying out steps of the method involving restricting food intake.

12) The method for human training coordinated by a computing interface of claim 6, wherein the method instructs the user to consume at least 130% more food than they ordinarily would before carrying out steps of the method involving restricting food intake.

13) The method for human training coordinated by a computing interface of claim 8, wherein the method instructs the user to consume at least 130% more food than they ordinarily would before carrying out steps of the method involving restricting food intake.

14) The method for human training coordinated by a computing interface of claim 9, wherein the method instructs the user to consume at least 130% more food than they ordinarily would before carrying out steps of the method involving restricting food intake.
